(19) United States
(12) Patent Application Publication
(10) Pub. No.: US 2017/0013556 A1
(43) Pub. Date: Jan. 12, 2017

(54) WIRELESS COMMUNICATION CONTROL DEVICE, WIRELESS COMMUNICATION CONTROL METHOD, STORAGE MEDIUM, AND WIRELESS COMMUNICATION CONTROL SYSTEM

(71) Applicant: NEC Communication Systems, Ltd., Tokyo (JP)

(72) Inventors: Toshiyasu TANAKA, Tokyo (JP); Stefan AUST, Tokyo (JP)

(73) Assignee: NEC Communication Systems, Ltd, Tokyo (JP)

(21) Appl. No.: 15/120,410

(22) PCT Filed: Feb. 23, 2015
(86) PCT No.: PCT/JP2015/000873

§ 371 Date: Aug. 19, 2016

(30) Foreign Application Priority Data
Feb. 28, 2014 (JP) 2014-038077

(51) Int. Cl. H04W 52/02

(52) U.S. Cl. CPC H04W 52/0216; H04W 84/12

(57) ABSTRACT

In order to solve a problem that, when a plurality of wireless communication modes are simultaneously used, interference between the plurality of wireless communication modes cannot be effectively prevented, a wireless communication control device according to the present invention includes a first communication mode control unit performing wireless communication in a first wireless communication mode, and a second communication mode control unit performing wireless communication in a second wireless communication mode. The second communication mode control unit detects a start of wireless communication in the first wireless communication mode, operates not to perform wireless communication in the second wireless communication mode during a wireless communication period in the first wireless communication mode, and operates to perform wireless communication in the second wireless communication mode outside a wireless communication period in the first wireless communication mode.

### TECHNICAL FIELD

The present invention relates to a wireless communication control device, a wireless communication control method, a storage medium, and a wireless communication control system.

### BACKGROUND ART

In Japan, IEEE 802.15.4g/e is currently available as one of wireless communication standards in a 920 MHz band. IEEE 802.15.4g/e is a standard with respect to a sub-GHz band, mainly used in a wireless personal area network (WPAN). In the description above, IEEE stands for Institute of Electrical and Electronics Engineers. Further, formulation of IEEE 802.11ah expected to be used as a sub-GHz version of wireless fidelity (WiFi) as one of international standards using the same 920 MHz band, is in progress. Accordingly, implementation of a surveillance system with a wireless sensor network utilizing the two standards is expected to take place in the near future.

When a WPAN standard typified by IEEE 802.15.4g/e and a wireless local area network (WLAN) standard typified by IEEE 802.11ah thus coexist, mutual interference arises between the different standards. Consequently, there is concern that a problem of degradation in communication quality, such as increase in delivery delay and decrease in a maximum throughput, may arise.

The problem described above may arise in a case other than coexistence of a WPAN standard and a WLAN standard. In other words, when a plurality of wireless communication modes coexist in a certain environment, a problem of possible mutual interference between the plurality of wireless communication modes arises. Therefore, development of a technology of reducing interference between different communication modes is awaited.

For example, PTL 1 is known as a technology aiming for reduction of such interference. PTL 1 describes a technology aiming for reduction of interference between different communication systems sharing a common wireless communication medium. Specifically, PTL 1 assumes standards corresponding to IEEE 802.15.3 and IEEE 802.11 as two interfering wireless communication modes. Then, in PTL 1, a contention access period (CAP) and a contention free period (CFP), corresponding to the IEEE 802.15.3 standard, are synchronized to a contention period (CP) and a CFP, corresponding to the IEEE 802.11 standard. Thus, according to PTL 1, unnecessary collision in communication can be prevented by synchronizing a CAP and a CFP corresponding to the IEEE 802.15.3 standard to a CP and CFP corresponding to the IEEE 802.11 standard.

Further, PTL 2 is known as a related technology. PTL 2 describes a technology for effectively switching a frequency band used in wireless communication between a plurality of wireless devices to another band. In the method described in PTL 2, a wireless device gives notice of a request for switching a first frequency band to a separate second frequency band. Another wireless device gives notice of a response for permitting switching to the second frequency band, gives notice of schedule information, and starts wireless communication, based on the schedule information. Such a method according to PTL 2 enables effective switching of a frequency band used in wireless communication to another band.

Further, PTL 3 is known as a related technology. PTL 3 describes a technology of, while operating a session in a first frequency band, setting an agreement for operating a session in a second frequency band, constructing a physical link in the second frequency band, and transferring the session to the second frequency band.

### CITATION LIST

### Patent Literature

[Patent Literature 1] Japanese Patent No. 4490824

[Patent Literature 2] Japanese Unexamined Patent Application Publication No. 2013-085099

[Patent Literature 3] Japanese Unexamined Patent Application Publication No. 2012-010316

### SUMMARY OF INVENTION

### Technical Problem

However, in the technology according to PTL 1, a length of a CP/CFP in a communication network corresponding to the IEEE 802.11 standard is limited to a length of a CAP/CFP corresponding to the IEEE 802.15.3 standard. Consequently, there is a problem that interference cannot be suppressed in a CP period corresponding to the IEEE 802.11 standard (a CAP period corresponding to the IEEE 802.15.3 standard). Further, due to existence of a CFP period corresponding to the IEEE 802.11 standard, communication is performed in accordance with a schedule during the CFP period. Accordingly, there is a problem that decrease in a maximum throughput may be caused.

Further, both of the technologies described in PTL 2 and 3 employ a mode using a plurality of channels for suppression of decrease in communication efficiency due to interference between a plurality of communication systems. Consequently there is a problem that both of the suppression methods described in PTL 2 and 3 are inefficient.

Thus, there is a problem that, when a plurality of wireless communication modes are simultaneously used, interference between the plurality of wireless communication modes cannot be effectively prevented.

Therefore, an object of the present invention is to provide a wireless communication control device, a wireless communication control method, a storage medium, and a wireless communication control system, being capable of solving the problem that, when a plurality of wireless communication modes are simultaneously used, interference between the plurality of wireless communication modes cannot be effectively prevented.

### Solution to Problem

The wireless communication control device of the present invention includes first communication mode control means for performing wireless communication in a first wireless communication mode, and second communication mode control means for performing wireless communication in a second wireless communication mode, wherein the second communication mode control means detects a start of wireless communication in the first wireless communication mode, operates not to perform wireless communication in the second wireless communication mode during a wireless communication period in the first wireless communication mode, and operates to perform wireless communication in the second wireless communication mode outside a wireless communication period in the first wireless communication mode.

The wireless communication control method of the present invention is a method of controlling wireless communication in a plurality of wireless communication modes, by use of a first communication mode control unit performing wireless communication in a first wireless communication mode, and a second communication mode control unit performing wireless communication in a second wireless communication mode, the method includes, by the second communication mode control unit, detecting a start of wireless communication in a first wireless communication mode, controlling wireless communication in a second wireless communication mode not to be performed during a wireless communication period in the first wireless communication mode, and controlling wireless communication in the second wireless communication mode to be performed outside a wireless communication period in the first wireless communication mode.

The storage medium of the present invention stores a program for causing a computer in a wireless communication control device controlling wireless communication in a plurality of wireless communication modes, by use of a first communication mode control unit performing wireless communication in a first wireless communication mode, and a second communication mode control unit performing wireless communication in a second wireless communication mode, to perform, processing of causing the second communication mode control unit to detect a start of wireless communication in the first wireless communication mode, operate not to perform wireless communication in the second wireless communication mode during a wireless communication period in the first wireless communication mode, and operate to perform wireless communication in the second wireless communication mode outside a wireless communication period in the first wireless communication mode.

The wireless communication control system of the present invention includes a first communication mode control device performing wireless communication in a first wireless communication mode, and a second communication mode control device performing wireless communication in a second wireless communication mode, wherein the second communication mode control device detects a start of wireless communication in the first wireless communication mode, operates not to perform wireless communication in the second wireless communication mode during a wireless communication period in the first wireless communication mode, and operates to perform wireless communication in the second wireless communication mode outside a wireless communication period in the first wireless communication mode.

### Advantageous Effects of Invention

The present invention is able to effectively prevent interference between a plurality of wireless communication modes when the plurality of wireless communication modes are simultaneously used.

### BRIEF DESCRIPTION OF DRAWINGS

FIG. 1 is a diagram illustrating a configuration example of a wireless sensor network according to a first exemplary embodiment of the present invention.

FIG. 2 is a block diagram illustrating a configuration example of a gateway illustrated in FIG. 1.

FIG. 3A is a diagram illustrating parameters used when WPAN-standard-based wireless communication is performed.

FIG. 3B is a diagram illustrating parameters used when WLAN-standard-based wireless communication is performed.

FIG. 4 is a block diagram illustrating a configuration example of a WPAN terminal illustrated in FIG. 1.

FIG. 5 is a block diagram illustrating a configuration example of a WLAN terminal illustrated in FIG. 1.

FIG. 6 is a block diagram illustrating a configuration example of a backhaul node illustrated in FIG. 1.

FIG. 7 is a sequence diagram illustrating an example of a control flow by a harmonized controller according to the first exemplary embodiment of the present invention.

FIG. 8 is a sequence diagram illustrating an operation example of the WPAN terminal according to the first exemplary embodiment of the present invention.

FIG. 9 is a sequence diagram illustrating an operation example of the WLAN terminal according to the first exemplary embodiment of the present invention.

FIG. 10 is a diagram illustrating WPAN-standard-based wireless communication and WLAN-standard-based wireless communication according to the first exemplary embodiment of the present invention.

FIG. 11 is a diagram illustrating another configuration example of a superframe length.

FIG. 12 is a diagram illustrating a configuration example of a wireless sensor network according to a second exemplary embodiment of the present invention.

FIG. 13 is a block diagram illustrating a configuration example of a backhaul node illustrated in FIG. 12.

FIG. 14 is a block diagram illustrating a configuration example of a gateway illustrated in FIG. 12.

FIG. 15 is a block diagram illustrating a configuration example of a wireless communication control device according to a third exemplary embodiment of the present invention.

### DESCRIPTION OF EMBODIMENTS

Next, exemplary embodiments of the present invention will be described in detail with reference to the drawings.

### First Exemplary Embodiment

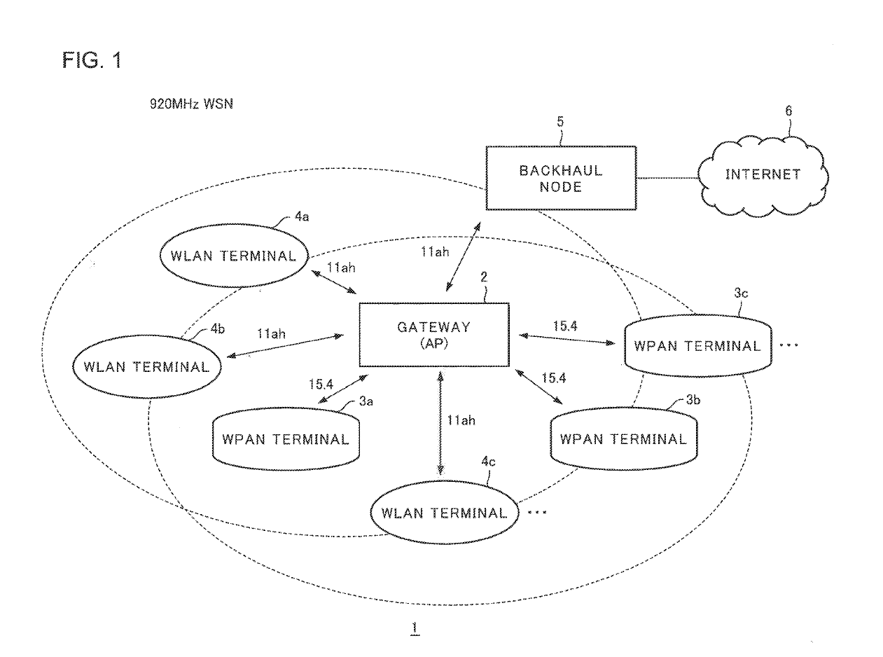

FIG. 1 is a diagram illustrating a configuration example of a wireless sensor network (WSN) 1 according to a first exemplary embodiment of the present invention. The wireless sensor network 1 is a wireless sensor network performing wireless communication by use of a 920 MHz band. Specifically, WPAN-standard-based wireless communication and WLAN-standard-based wireless communication are performed in the wireless sensor network 1 by use of the 920 MHz band.

The wireless sensor network 1 includes a gateway 2 (wireless communication control device), WPAN terminals 3 (WPAN terminals 3a, 3b, 3c, . . . ), WLAN terminals 4 (WLAN terminals 4a, 4b, 4c, . . . ), and a backhaul node 5. As described later, the WPAN terminal 3 and the WLAN terminal 4 according to the present exemplary embodiment correspond to sensor nodes in the wireless sensor network 1. Further, the gateway 2 corresponds to a sink node in the wireless sensor network 1.

While a case that numbers of the WPAN terminals 3 and the WLAN terminals 4 are respectively “3” is exemplified in FIG. 1, this is merely an example, and the present exemplary embodiment is not dependent on a number of the WPAN terminals 3 and a number of the WLAN terminals 4. For example, numbers of the WPAN terminals 3 and the WLAN terminals 4 may be two, or four or more, respectively. Further, a number of the WPAN terminals 3 and a number of the WLAN terminals 4 may differ.

Wireless communication by radio waves can be performed between the gateway 2 and the WPAN terminal 3, and between the gateway 2 and the WLAN terminal 4. Specifically, WPAN-standard-based wireless communication (such as IEEE 802.15.4g/e) is performed between the gateway 2 and the WPAN terminal 3, and WLAN-standard-based wireless communication (such as IEEE 802.11ah) is performed between the gateway 2 and the WLAN terminal 4.

Further, the gateway 2 and the backhaul node 5 are able to perform WLAN-standard-based wireless communication (such as IEEE 802.11ah). Additionally, the backhaul node 5 is connected to the Internet 6 in a wired manner. It is assumed in the present exemplary embodiment that center frequencies of communication channels respectively used between the gateway 2 and the WPAN terminal 3, and between the gateway 2 and the WLAN terminal 4, are identical (such as 924 MHz).

Further, as illustrated in FIG. 1, the wireless sensor network 1 according to the present exemplary embodiment forms a star network topology centered on the gateway 2. Accordingly, data sensed by the WPAN terminal 3 and the WLAN terminal 4 (sensor data) are aggregated into the gateway 2, and transmitted to the Internet 6 through, for example, the backhaul node 5. While a case that the wireless sensor network 1 according to the present exemplary embodiment forms a star network topology is exemplified, the wireless sensor network 1 may form, for example, a mesh network topology.

The gateway 2 is a coordinator in a WPAN standard, and, at the same time an access point (AP) in a WLAN standard. The coordinator refers to a node playing a central role in controlling communication in a network in a WPAN standard. Further, the access point refers to a node playing a central role in controlling communication in a network in a WLAN standard. In other words, the gateway 2 has a function of controlling both wireless communication using a WPAN standard and wireless communication using a WLAN standard, in the wireless sensor network 1.

Further, as described above, the gateway 2 also serves as a sink node in the wireless sensor network 1. That is, the gateway 2 has a function of collecting data sensed by the WPAN terminal 3 and the WLAN terminal 4, being sensor nodes. The gateway 2 according to the present exemplary embodiment transmits data collected from the WPAN terminal 3 and the WLAN terminal 4 to the Internet 6 through the backhaul node 5. The gateway 2 may have a function such as making a database of collected data, and performing predetermined calculation processing by use of collected data.

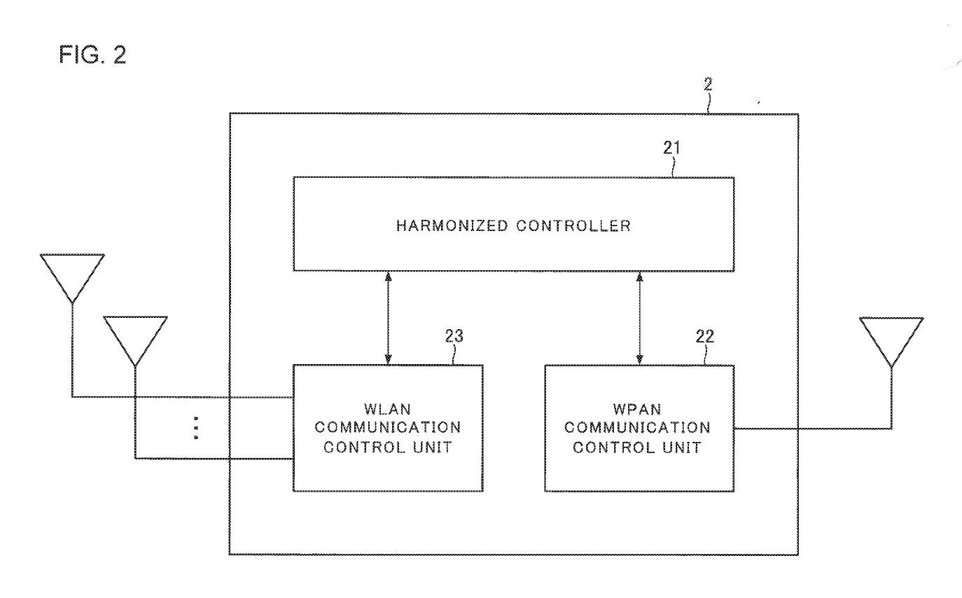

With reference to FIG. 2, the gateway 2 includes a harmonized controller 21 (control means), a WPAN communication control unit 22 (first communication mode control unit), and a WLAN communication control unit 23 (second communication mode control unit).

The harmonized controller 21 has functions such as having predetermined control over the WPAN communication control unit 22, and having predetermined control over the WLAN communication control unit 23. Specifically, the harmonized controller 21 according to the present exemplary embodiment controls a superframe length SD and a beacon interval BI being parameters used when WPAN-standard-based wireless communication is performed. Further, the harmonized controller 21 controls a network allocation vector (NAV) length DUR being a parameter used (included in a CTS (clear to send) frame described later) when WLAN-standard-based wireless communication is performed. Additionally, the harmonized controller 21 controls a transmission timing of a beacon by the WPAN communication control unit 22 and a transmission timing of a CTS frame by the WLAN communication control unit 23. Further, the harmonized controller 21 issues an instruction on a start of WLAN-standard-based wireless communication. Then, as described above, the harmonized controller 21 collects data sensed by the WPAN terminal 3 and the WLAN terminal 4, and transfers the data to the backhaul node 5.

Thus, the harmonized controller 21 has various functions. Roles of the harmonized controller 21 are listed, for example, as follows:
managing an SD and a BI in a WPAN,
issuing an instruction on a beacon transmission timing in a WPAN (instruction on a start of communication in a WPAN),
managing an NAV length in a WLAN,
issuing an instruction on a CTS transmission timing in a WLAN,
issuing an instruction on a start of communication in a WLAN, and
transferring collected WPAN/WLAN communication data to the backhaul node 5.

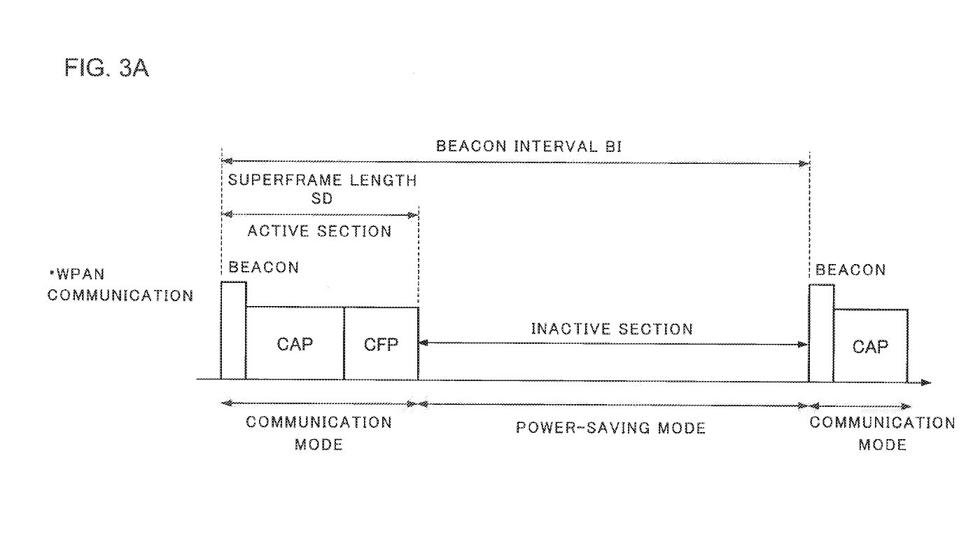

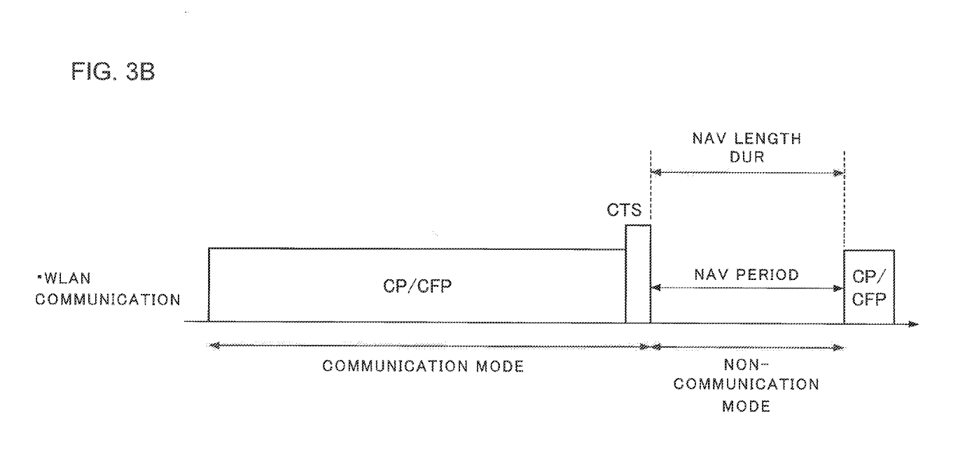

FIG. 3A is a diagram illustrating parameters used when WPAN-standard-based wireless communication is performed. FIG. 3B is a diagram illustrating parameters used when WLAN-standard-based wireless communication is performed.

By use of FIGS. 3A and 3B, the superframe length SD, the beacon interval BI, the NAV length DUR, and the CTS frame (a wireless communication signal including information indicating an active period) controlled by the harmonized controller 21 will be described in detail.

With reference to FIG. 3A, the superframe according to the present exemplary embodiment is composed of three parts: a beacon being a synchronization signal, a contention access period (CAP period), and a contention free period (CFP period). The CAP period refers to a period in which a communication right is contended for in carrier sense multiple access/collision avoidance (CSMA/CA), and is a period in which a channel usage right is acquired for communication. In the CAP period, all WPAN terminals 3 are able to access the channel. Further, the CFP period refers to a period in which the gateway 2 being a coordinator performs communication, by performing schedule management of a communication timing. In the CFP period, communication is controlled to be performed only by a WPAN terminal 3 permitted by the gateway 2. Thus, the superframe according to the present exemplary embodiment is composed of the beacon, the CAP period, and the CFP period. The harmonized controller 21 controls the superframe length SD being a length of such a superframe, by, for example, controlling lengths of the CAP period and the CFP period.

Further, as illustrated in FIG. 3A, the beacon interval BI refers to an interval between transmission of a beacon and transmission of the next beacon. The superframe length SD makes up part of the beacon interval BI. Consequently, the harmonized controller 21 controls the beacon interval BI to be longer than the superframe length SD.

Thus, the harmonized controller 21 controls the superframe length SD and the beacon interval BI. As described above, during the superframe length controlled by the harmonized controller 21, transmission of a beacon and wireless communication in the CAP period and the CFP period are performed. On the other hand, wireless communication using a WPAN standard is not performed after elapse of the superframe length SD until next beacon transmission (in a period of the beacon interval BI subtracted by the superframe length SD). In other words, the harmonized controller 21 controls an active section (active period) being a period in which communication is performed by use of a WPAN standard, and an inactive section (inactive period) being a period in which communication is not performed by use of a WPAN standard, by controlling the superframe length SD and the beacon interval BI.

The harmonized controller 21 according to the present exemplary embodiment notifies the WPAN communication control unit 22 of the controlled superframe length SD and the beacon period BI as described above. That is, the harmonized controller 21 sets the active section and the inactive section to the WPAN communication control unit 22. Consequently, as described later, the WPAN communication control unit 22 performs wireless communication in the active section, in accordance with the notification from the harmonized controller 21, while the unit does not perform wireless communication in the inactive section. Further, the WPAN communication control unit 22 transmits a beacon including information indicating the superframe length SD and the beacon interval BI received from the harmonized controller 21. Accordingly, the WPAN terminal 3 is able to learn the superframe length SD and the beacon interval BI by receiving the beacon transmitted by the WPAN communication control unit 22. Consequently, the WPAN terminal 3 performs wireless communication in the active section, while the terminal does not perform wireless communication in the inactive section. Thus, the harmonized controller 21 controls wireless communication using a WPAN standard by notifying the WPAN communication control unit 22 of the superframe length SD and the beacon period BI.

The CTS frame refers to a signal for permitting transmission. The CTS frame is a signal generally transmitted in response to a request to send (RTS) frame. The CTS frame includes information indicating a period in which a channel is occupied in transmission. The period occupying the channel is the NAV length DUR.

With reference to FIG. 3B, by transmission of a CTS frame, wireless communication using a WLAN standard is not performed for a period of the NAV length DUR indicated by information included in the CTS frame. Specifically, as described later, when transmitting a CTS frame, in accordance with an instruction from the harmonized controller 21, the WLAN communication control unit 23 transitions to a non-communication mode for a period of the NAV length indicated by information included in the CTS frame. Further, the WLAN terminal 4 receiving a CTS frame, transitions to the non-communication mode in which communication is not performed for a period of the NAV length DUR indicated by information included in the received CTS frame. Consequently, wireless communication using a WLAN standard is controlled for a period of the NAV length DUR. Thus, the harmonized controller controls a period in which WLAN-standard-based wireless communication is not performed, by instructing the WLAN communication control unit 23 to transmit a CTS frame.

The period in which a channel is occupied (the period in which wireless communication is performed) according to the present exemplary embodiment refers to a period is which the channel is used in WPAN-standard-based wireless communication. Accordingly, the period in which the channel is occupied (NAV length DUR) described above has a same length as the superframe length SD and the active section in a WPAN standard.

Further, the harmonized controller 21 according to the present exemplary embodiment instructs the WLAN communication control unit 23 to transmit a CTS frame immediately before the WPAN communication transitions to the active section. Specifically, the harmonized controller 21 instructs the WPAN communication control unit 22 to start wireless communication using a WPAN standard, and subsequently, at a stage when a period of the beacon interval BI elapses, instructs the WLAN communication control unit 23 to transmit a CTS frame. Alternatively, at a stage when a period of the beacon interval BI elapses after issuing an instruction to transmit a CTS frame, the harmonized controller 21 instructs the WLAN communication control unit 23 to transmit a CTS frame. As described above, in a WPAN standard, a beacon is transmitted (transition to the active section takes place) every time a period of the beacon interval BI elapses. Therefore, by issuing an instruction to transmit a CTS frame correspondingly to the beacon interval BI, the harmonized controller 21 is able to issue an instruction to transmit a CTS frame in synchronization with (immediately before) a timing of the WPAN communication transitioning to the active section. Further, as described above, the NAV length DUR is controlled to have a same length as the superframe length SD and the active section in a WPAN standard. Therefore, the NAV length DUR elapses at the same timing as a timing of the WPAN communication transitioning to the inactive section. That is, the WLAN communication is able to transition to the communication mode at a timing of the WPAN communication transitioning to the inactive section.

By thus controlling a transmission timing of a CTS frame and the NAV length DUR, the harmonized controller 21 is able to control wireless communication using a WLAN standard not to be performed during a wireless communication period using a WPAN standard (active section). Further, while limiting wireless communication using a WLAN standard, as described above, the harmonized controller 21 is able to control wireless communication using a WLAN standard to be performed during a period in which wireless communication using a WPAN standard is not performed (inactive section).

A wireless frame in which the harmonized controller 21 issues an instruction on transmission does not necessarily be a CTS frame, as long as the wireless frame includes the aforementioned NAV length DUR.

The WPAN communication control unit 22 has a function of performing WPAN-standard (first wireless communication mode)-based wireless communication with the WPAN terminal 3. As illustrated in FIG. 2, the WPAN communication control unit 22 includes an antenna unit and performs wireless communication with the WPAN terminal 3 through the antenna unit. Further, the WPAN communication control unit 22 according to the present exemplary embodiment performs wireless communication by use of a 920 MHz band.

As described above, the superframe length SD and the beacon interval BI are notified to the WPAN communication control unit 22 from the harmonized controller 21. In other words, the active section and the inactive section are set to the WPAN communication control unit 22 by the harmonized controller 21. Consequently, the WPAN communication control unit 22 operates to perform wireless communication in the active section, while the unit operates not to perform wireless communication in the inactive section.

Specifically, the WPAN communication control unit 22 transmits a beacon in response to an instruction from the harmonized controller 21, or every time a period of the beacon interval BI elapses. Subsequently, the WPAN communication control unit 22 performs wireless communication with the WPAN terminal 3 in the CAP and CFP periods included in the active period. Then, the WPAN communication control unit 22 transitions to the inactive section after elapse of the active section until a next beacon transmission timing. Further, the WPAN communication control unit 22 according to the present exemplary embodiment operates in a communication mode consuming power to perform wireless communication, in the active section, while the unit transitions to a power-saving mode reducing power consumption by not performing wireless communication, in the inactive section.

The WLAN communication control unit 23 has a function of performing WLAN-standard (second wireless communication mode)-based wireless communication with the WLAN terminal 4 and the backhaul node 5. As illustrated in FIG. 2, the WLAN communication control unit 23 includes an antenna unit, and performs wireless communication with the WLAN terminal 4 and the backhaul node 5 through the antenna unit. Further, the WLAN communication control unit 23 according to the present exemplary embodiment performs wireless communication by use of a 920 MHz band.

As described above, an instruction to start communication and an instruction to transmit a CTS frame are issued to the WLAN communication control unit 23 from the harmonized controller 21. The WLAN communication control unit 23 starts wireless communication (transitions to the communication mode), in accordance with an instruction from the harmonized controller 21. Subsequently, the WLAN communication control unit 23 transmits a CTS frame and transitions to the non-communication mode for a period of the NAV length DUR, every time an instruction is issued from the harmonized controller 21 to transmit a CTS frame.

Specifically, the WLAN communication control unit 23 detects a start of WPAN-standard-based wireless communication by receiving an instruction from the harmonized controller 21 to transmit a CTS frame. Further, the WLAN communication control unit 23 operates not to perform WLAN-standard-based wireless communication during a WPAN-standard-based wireless communication period, under control of the harmonized controller 21 (by receiving an instruction to transmit a CTS frame). On the other hand, the WLAN communication control unit 23 operates to perform WLAN-standard-based wireless communication outside a WPAN-standard-based wireless communication period, under control of the harmonized controller 21 (in accordance with the NAV length DUR included in a CTS frame). In a WLAN communication mode, any access mode defined in a WLAN standard, such as a point coordination function (PCF), a distributed coordination function (DCF), and a hybrid coordination function (HCF), can be used. Further, in the WLAN communication mode, wireless communication may be performed by use of either one of a CP and a CFP.

The WPAN terminal 3 has a function of performing wireless communication with the WPAN communication control unit 22 in the gateway 2 by use of a WPAN standard. Further, the WPAN terminal 3 has a general function as a sensor node.

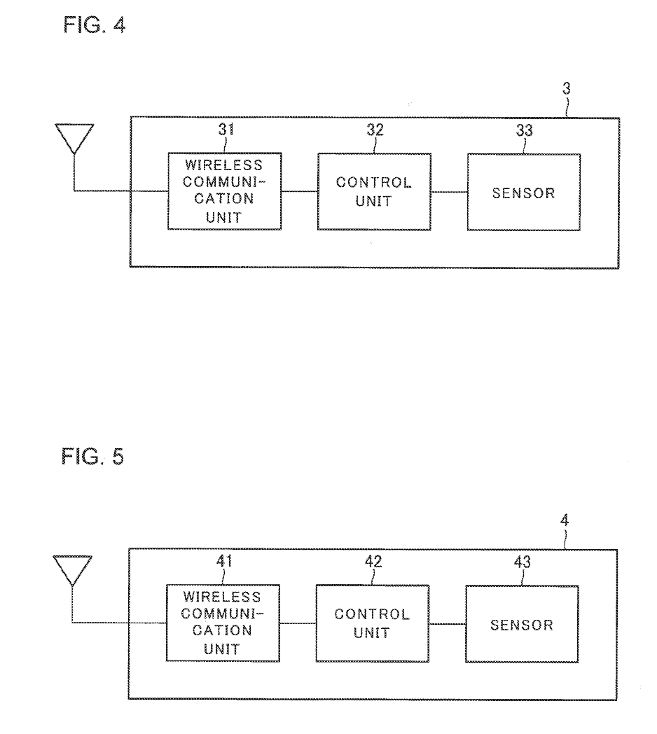

With reference to FIG. 4, the WPAN terminal 3 includes, for example, a wireless communication unit 31, a control unit 32, and a sensor 33. A configuration of the WPAN terminal 3 is not limited to the above.

A specific configuration of the WPAN terminal 3 is not particularly limited as long as the function of performing communication by use of a WPAN standard and the function as a sensor node are included.

The wireless communication unit 31 has a function of performing wireless communication by use of a WPAN standard. The wireless communication unit 31 includes an antenna unit and performs wireless communication with the WPAN communication control unit 22 through the antenna unit. The wireless communication unit 31 according to the present exemplary embodiment performs wireless communication with the WPAN communication control unit 22 by use of a 920 MHz band.

The control unit 32 has a function of controlling the entire WPAN terminal 3. The control unit 32 controls, for example, acquisition of sensor data from the sensor 33, transmission of acquired sensor data, and path configuration. Further, the control unit 32 controls transition to an active section and transition to an inactive section, in accordance with information about a superframe length SD and a beacon interval BI, included in a beacon transmitted from the WPAN communication control unit 22. The control unit 32 controls the WPAN terminal 3 to, for example, halt the functions of the wireless communication unit 31, the control unit 32, and the sensor 33, and transition to a power-saving mode, during the inactive section.

The sensor 33 has a function of sensing predetermined data such as temperature and a power value. Further, the sensor 33 transmits sensed data (sensor data) to the control unit 32. The WPAN terminal 3 may be equipped with an actuator such as a motor and a switch instead of the sensor 33.

With such a configuration, the wireless communication unit 31 in the WPAN terminal 3 receives a beacon transmitted from the WPAN communication control unit 22. Next, the control unit 32 controls the active section (during a period of the superframe length SD) and the inactive section (after elapse of a period of the superframe length SD until next beacon transmission), in accordance with information about the superframe length SD and the beacon interval BI included in the beacon. In other words, the control unit 32 controls the WPAN terminal 3 to perform wireless communication in the active section, while the unit controls the terminal not to perform wireless communication in the inactive section. Consequently, the WPAN terminal 3 transitions to the active section and the inactive section in synchronization with timings of the WPAN communication control unit 22 transitioning to the active section and the inactive section, respectively.

The WLAN terminal 4 has a function of performing wireless communication with the WLAN communication control unit 23 in the gateway 2 by use of a WLAN standard. Further, the WLAN terminal 4 has a general function as a sensor node.

With reference to FIG. 5, the WLAN terminal 4 includes, for example, a wireless communication unit 41, a control unit 42, and a sensor 43. A configuration of the WLAN terminal 4 is not limited to the above. A specific configuration of the WLAN terminal 4 is not particularly limited as long as the function of performing communication by use of a WLAN standard and the function as a sensor node are included.

The wireless communication unit 41 has a function of performing wireless communication by use of a WLAN standard. The wireless communication unit 41 includes an antenna unit and performs wireless communication with the WLAN communication control unit 23 through the antenna unit. The wireless communication unit 41 according to the present exemplary embodiment performs wireless communication with the WLAN communication control unit 23 by use of a 920 MHz band.

The control unit 42 has a function of controlling the entire WLAN terminal 4. The control unit 42 controls, for example, acquisition of sensor data from the sensor 43, transmission of acquired sensor data, and path configuration. Further, the control unit 42 controls the WLAN terminal 4 to transition to a non-communication mode for a period of a NAV length DUR included in a CTS frame transmitted from the WLAN communication control unit 23. Further, the control unit 42 controls the WLAN terminal 4 to transition to a communication mode when a period of the NAV length DUR elapses.

A configuration of the sensor 43 is similar to a configuration of the sensor 33 included in the aforementioned WPAN terminal 3. Accordingly, description is omitted.

With such a configuration, the wireless communication unit 41 in the WLAN terminal 4 receives a CTS frame transmitted from the WLAN communication control unit 23. Next, the control unit controls the WLAN terminal 4 to transition to the non-communication mode for a period of the NAV length DUR included in the CTS frame. Consequently, the WLAN terminal 4 transitions to the non-communication mode in synchronization with a timing of the WLAN communication control unit 23 transitioning to the non-communication mode. Further, the control unit 42 causes the WLAN terminal to transition to the communication mode when a period of the NAV length DUR elapses. Consequently, the WLAN terminal 4 transitions to the communication mode in synchronization with a timing of the WLAN communication control unit 23 transitioning to the communication mode. In other words, the WLAN terminal 4 is controlled not to perform wireless communication during a WPAN-standard-based wireless communication period (active section), while the terminal is controlled to perform wireless communication outside a WPAN-standard-based wireless communication period (during an inactive section).

The backhaul node 5 is a node relaying sensor data collected by the gateway 2 to the Internet 6. As described above, the backhaul node 5 according to the present exemplary embodiment performs wireless communication with the WLAN communication control unit 23 in the gateway 2 by use of a WLAN standard. The backhaul node 5 and the gateway 2 may be connected in a wired manner.

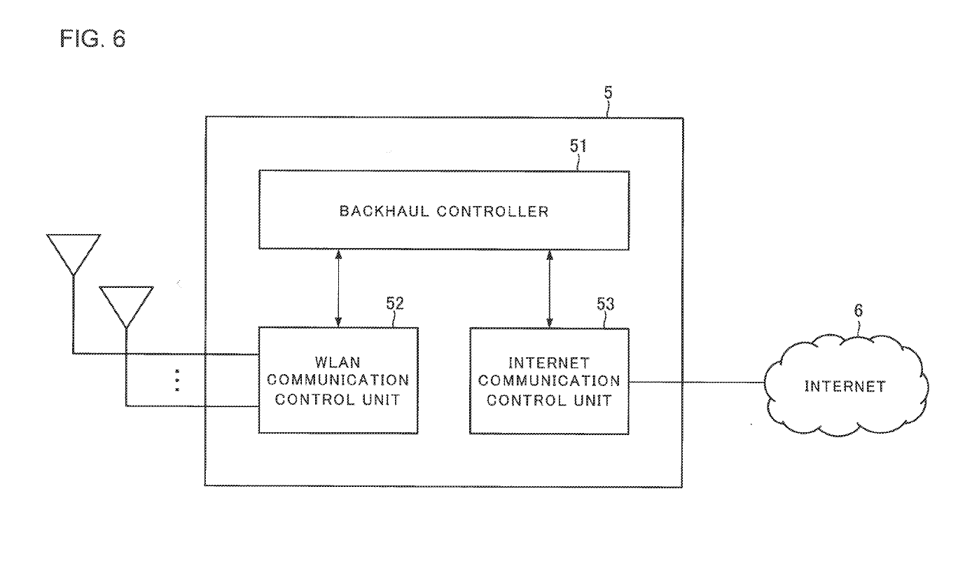

With reference to FIG. 6, the backhaul node 5 includes a backhaul controller 51, a WLAN communication control unit 52, and an Internet communication control unit 53.

The backhaul controller 51 has a function of controlling the WLAN communication control unit 52 and the Internet communication control unit 53. The backhaul controller 51 transfers to a user sensor data acquired by the WLAN communication control unit 52 by communicating with the gateway 2, through, for example, the Internet communication control unit 53 and the Internet 6.

The WLAN communication control unit 52 has a function of performing wireless communication with the WLAN communication control unit 23 in the gateway 2, by use of a WLAN standard. As illustrated in FIG. 6, the WLAN communication control unit 52 includes an antenna unit and performs wireless communication with the WLAN communication control unit 23 in the gateway 2 through the antenna unit. Further, the WLAN communication control unit 52 according to the present exemplary embodiment performs wireless communication by use of a 920 MHz band.

The Internet communication control unit 53 is connected to the Internet 6 in a wired manner. The Internet communication control unit 53 is used in communication with the Internet 6. For example, as described above, the Internet communication control unit 53 is used when sensed sensor data are transferred to a user through the Internet.

Next, an operation of the wireless sensor network 1 will be described.

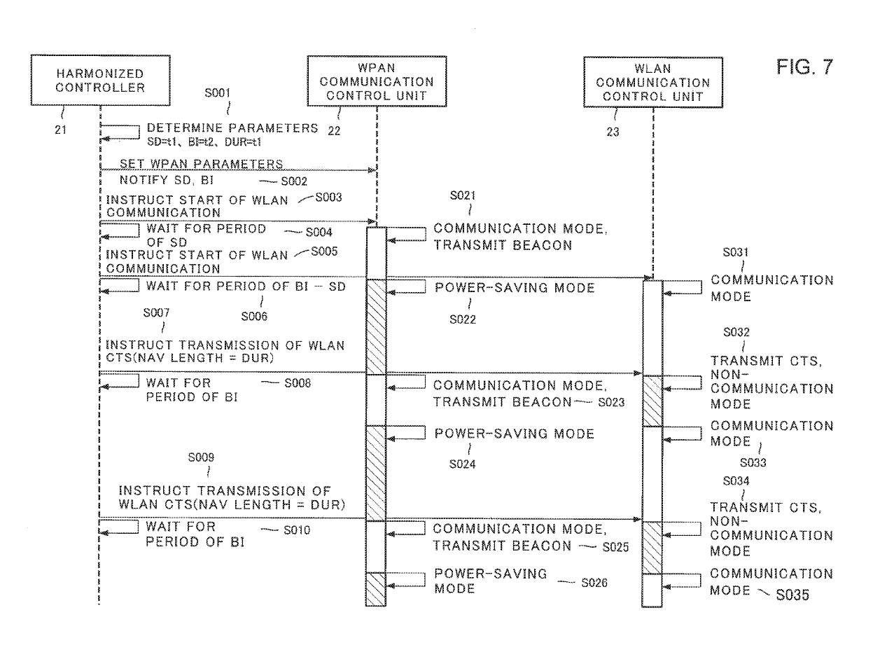

First, a control flow by the harmonized controller 21 (operations of the harmonized controller 21, the WPAN communication control unit 22, and the WLAN communication control unit 23) will be described by use of FIG. 7.

The harmonized controller 21 first determines predetermined parameters. Specifically, the harmonized controller 21 determines a superframe length SD, a beacon interval BI, and an NAV length DUR (Step S001). For example, the harmonized controller 21 determines superframe length SD=t1, beacon interval BI=t2, and NAV length DUR=t1, as the parameters described above.

The harmonized controller 21 notifies the WPAN communication control unit 22 of the superframe length SD and the beacon interval BI (Step S002). In other words, the harmonized controller 21 sets an active section and an inactive section to the WPAN communication control unit 22.

The harmonized controller 21 instructs the WPAN communication control unit 22 to start WPAN communication (Step S003).

After issuing the instruction to start the WPAN communication, the harmonized controller 21 waits for a period of the superframe length SD (t1) (Step S004).

After waiting for a period of the superframe length SD, the harmonized controller 21 instructs the WLAN communication control unit 23 to start WLAN communication (Step S005).

Subsequently, the harmonized controller 21 waits for a period of (t2−t1) obtained by subtracting the superframe length SD from the beacon interval BI (Step S006). In other words, the harmonized controller 21 waits from a timing of issuing an instruction to start WPAN communication until a period of the beacon interval BI elapses.

The harmonized controller 21 instructs the WLAN communication control unit 23 to transmit a CTS frame (Step S007). The harmonized controller 21 thereafter repeats an operation (Step S010, . . . ) of waiting for a period of the beacon interval BI (t2) (Step S008) and subsequently instructing the WLAN communication control unit 23 to transmit a CTS frame (Step S009).

The WPAN communication control unit 22 is first notified of a superframe length SD and a beacon interval BI by the harmonized controller 21 (Step S002). In other words, the WPAN communication control unit 22 is set an active section and an inactive section by the harmonized controller 21.

Next, the WPAN communication control unit 22 receives an instruction to start WPAN communication from the harmonized controller 21 (Step S003). Then, the WPAN communication control unit 22 transitions to a communication mode (Step S021). After transitioning to the communication mode, the WPAN communication control unit 22 transmits a beacon and performs wireless communication based on a CAP period and a CFP period.

As described above, the active section and the inactive section are set to the WPAN communication control unit 22. Accordingly, after performing wireless communication during the active section, the WPAN communication control unit 22 transitions to the inactive section. In other words, after performing wireless communication for a period of the superframe length SD (t1), the WPAN communication control unit 22 transitions to the inactive section (power-saving mode) (Step S022). Then, the WPAN communication control unit 22 waits for a period of (t2−t1) obtained by subtracting the superframe length SD from the beacon interval BI. In other words, the WPAN communication control unit 22 waits from the previous beacon transmission until a period of the beacon interval BI elapses.

Subsequently, the WPAN communication control unit 22 transitions to the communication mode and transmits a beacon (Step S023). The WPAN communication control unit 22 thereafter repeats an operation (Step S026, . . . ) of performing wireless communication for a period of the superframe length SD (t1) (active section), and subsequently transitioning to the power-saving mode (inactive section) (Step S024), and then, waiting for a period of the beacon interval BI—the superframe length SD (t2−t1), transitioning to the communication mode again, and transmitting a beacon (Step S025).

The WLAN communication control unit 23 first receives an instruction to start communication from the harmonized controller 21 (Step S005). Then, the WLAN communication control unit 23 transitions to a communication mode (Step S031). The WLAN communication control unit 23 may use either one of a CP and a CFP in the communication mode.

The WLAN communication control unit 23 receives an instruction to transmit a CTS frame from the harmonized controller 21 (Step S007). Then, upon receipt of the instruction, WLAN communication control unit 23 transmits a CTS frame. Further, after transmitting the CTS frame, the WLAN communication control unit 23 transitions to a non-communication mode for a period of a NAV length DUR (t1) (Step S032).

Then, after a period of the NAV length DUR (t1) elapses, the WLAN communication control unit 23 transitions to the communication mode (Step S033). The WLAN communication control unit 23 thereafter repeats an operation of transmitting a CTS frame upon receipt of an instruction to transmit a CTS frame from the harmonized controller 21, and subsequently transitioning to the non-communication mode (Step S034), and an operation of transitioning to the communication mode after elapse of a period of the NAV length DUR (Step S035).

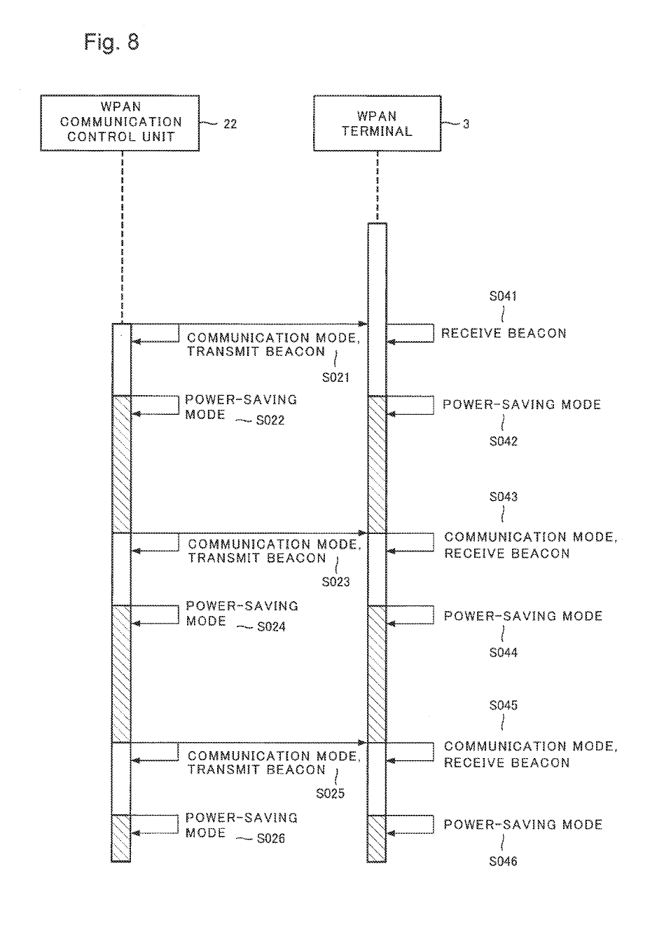

Next an operation of the WPAN terminal 3 will be described by use of FIG. 8.

The WPAN terminal 3 receives (Step S041) a beacon transmitted by the WPAN communication control unit 22 (Step S021). The beacon includes information indicating a superframe length SD and a beacon interval BI. Accordingly, after receiving the beacon, the WPAN terminal 3 performs wireless communication for a period of the superframe length SD. Subsequently, the WPAN terminal 3 transitions to an inactive section (power-saving mode) (Step S042).

Next, after a period of the beacon interval BI subtracted by the superframe length SD elapses (after a period of the beacon interval BI elapses from the previous reception of a beacon), the WPAN terminal 3 transitions to a communication mode. Then, the WPAN terminal 3 receives (Step S043) a beacon transmitted by the WPAN communication control unit 22 (Step S023). The WPAN terminal 3 thereafter repeats an operation (Step S046, . . . ) of performing wireless communication for a period of the superframe length SD included in the beacon, and subsequently transitioning to the power-saving mode (Step S044), and then, after a period of the beacon interval BI subtracted by the superframe length SD elapses, transitioning to the communication mode to receive a beacon (Step S045).

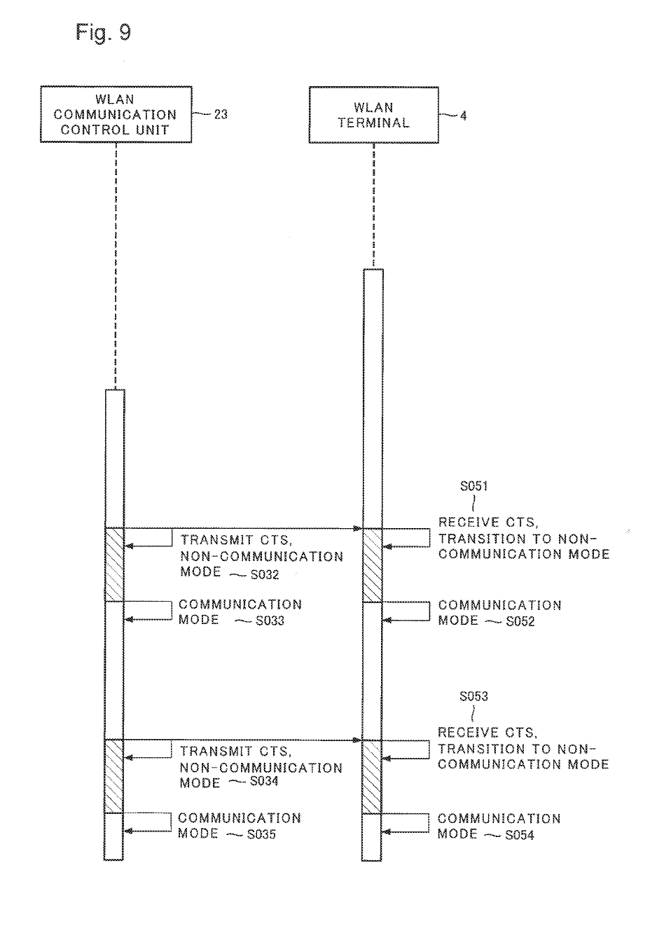

Next, an operation of the WLAN terminal 4 will be described by use of FIG. 9.

The WLAN terminal 4 receives a CTS frame transmitted by the WLAN communication control unit 23 (Step S032). Then the WLAN terminal 4 transitions to a non-communication mode for a period of a NAV length DUR included in a CTS frame (Step S051).

After a period of the NAV length DUR elapses, the WLAN terminal 4 transitions to a communication mode (Step S052). The WLAN terminal 4 thereafter repeats an operation of transitioning to the non-communication mode upon receipt of a CTS frame transmitted by the WLAN communication control unit 23 (Step S053), and an operation of transitioning to the communication mode after a period of the NAV length DUR elapses (Step S054).

Thus, the gateway 2 according to the present exemplary embodiment includes the harmonized controller 21, the WPAN communication control unit 22, and the WLAN communication control unit 23. With such a configuration, the harmonized controller 21 is able to set an active section and an inactive section (is able to set a superframe length SD and a beacon interval BI) to the WPAN communication control unit 22. Further, the harmonized controller 21 is able to instruct the WLAN communication control unit 23 to transmit a CTS frame including a NAV length DUR having a length identical to the active section, immediately before the WPAN communication control unit 22 transitions to the active section. Consequently, the harmonized controller 21 is able to control WLAN-standard-based wireless communication not to be performed during a WPAN-standard-based wireless communication period, while the controller is able to control WLAN-standard-based wireless communication to be performed outside a WPAN-standard-based wireless communication period.

Thus interference between WPAN-standard-based communication and WLAN-standard-based communication can be prevented. In other words, when a plurality of wireless communication modes (a WPAN-standard-based wireless communication mode and a wireless-LAN-standard-based wireless communication mode) are simultaneously used, interference between the plurality of wireless communication modes can be effectively prevented.

Specifically, with the aforementioned configuration, there is no interference from a WLAN standard during a WPAN-standard-based communication period. Therefore, decrease in a maximum throughput due to interference from a WLAN standard can be suppressed. Further, a longer period of a power-saving mode contributes to a longer lifetime of the wireless sensor network 1. Furthermore, there is no interference from a WPAN standard during a WLAN-standard-based communication period. Therefore, decrease in a maximum throughput due to interference from a WPAN standard can be suppressed. Additionally, communication may be performed with either one of a CP and a CFP during a WLAN-standard-based communication period, and therefore wireless communication can be used without considering a CP/CFP limitation.

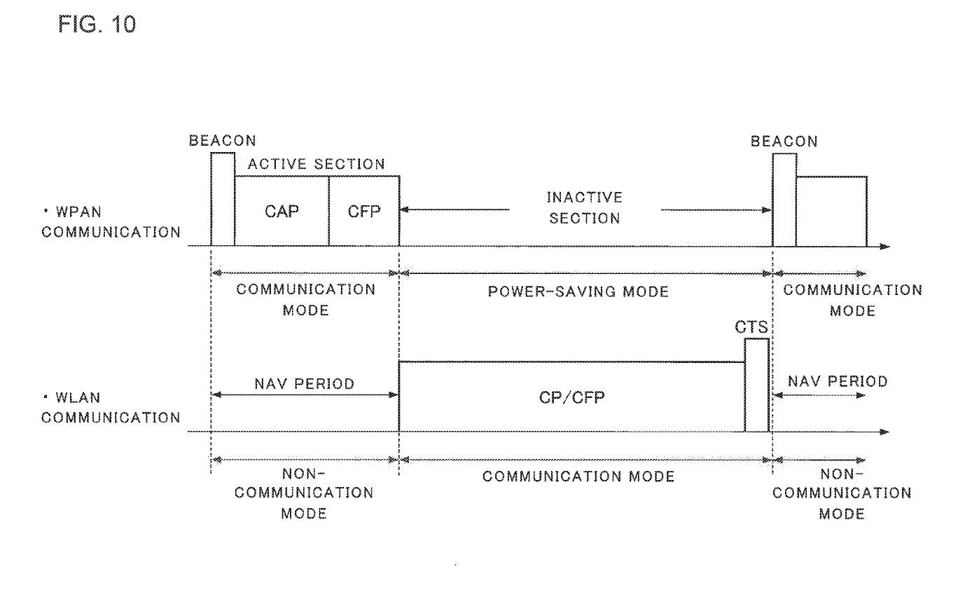

FIG. 10 illustrates an example of WPAN-standard-based wireless communication and WPAN-standard-based wireless communication, respectively performed under control of the harmonized controller 21 as described above.

With reference to FIG. 10, WPAN-standard-based wireless communication repeats an active section (communication mode, superframe length SD) composed of a beacon, a CAP period, and a CFP period, and an inactive section (power-saving mode) being a period in which wireless communication is not performed. Further, WLAN-standard-based wireless communication is performed while the WPAN-standard-based wireless communication is in the inactive section. Then, by a CTS frame being transmitted immediately before the WPAN-standard-based wireless communication transitions to the active section, the WLAN-standard-based wireless communication transitions to a non-communication mode while the WPAN-standard-based wireless communication is in the active section. By thus separating a period in which WPAN-standard-based wireless communication is performed and a period in which WLAN-standard-based wireless communication is performed, interference between the WPAN-standard-based wireless communication and the WLAN-standard-based wireless communication can be prevented.

A case according to the present exemplary embodiment that a beacon includes information about a superframe length SD and a beacon interval BI has been described. However, the present invention may be implemented without being limited to the case described above. For example, a case that a beacon only includes information about a superframe length SD may be considered. In such a configuration, when instructing the WLAN communication control unit 23 to transmit a CTS frame, the harmonized controller 21, for example, instructs the WPAN communication control unit 22 to transmit a wake-up signal. In this case, the WPAN terminal 3 is able to receive the wake-up signal.

Further, a CFP period included in a superframe length SD based on a WPAN standard is a period that can be used for irregular high-priority communication such as emergency data transmission (such as a fire alert). Accordingly, when there is no emergency data transmission, the CFP period may be used for WLAN communication instead of WPAN communication.

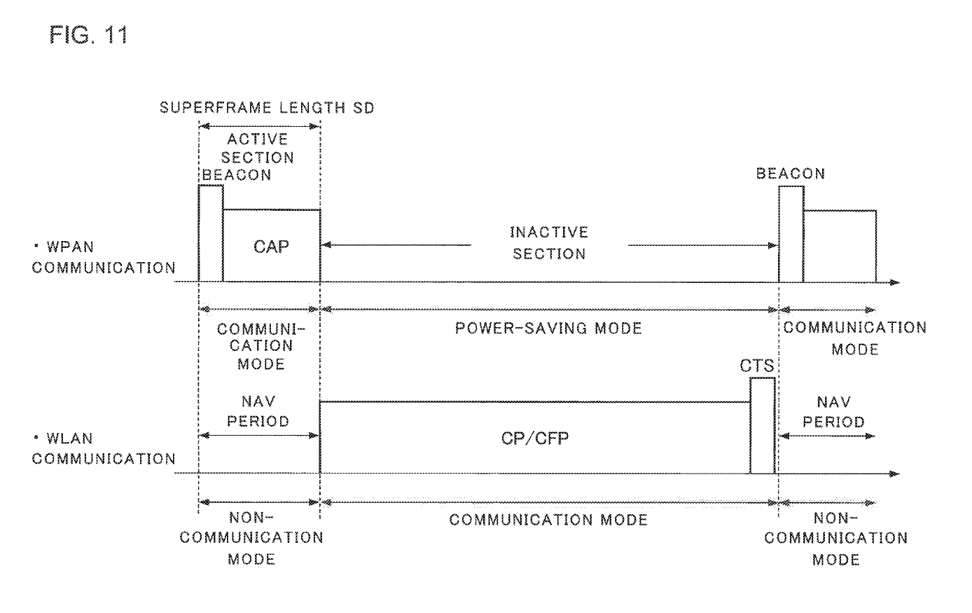

With reference to FIG. 11, the harmonized controller 21 sets a superframe composed of a beacon and a CAP period. Thus, a configuration of a superframe set by the harmonized controller 21 does not necessarily be composed of a beacon, a CAP period, and a CFP period. Further, in FIG. 11, the inactive section based on a WPAN standard is lengthened by a CFP period, while the communication mode period based on a WLAN standard is lengthened. Thus, the harmonized controller 21 may control the communication mode period based on a WLAN standard to be lengthened, by not setting a CFP period to the active section based on a WPAN standard.

Further, a case of using the present invention in a wireless sensor network has been described as an implementation example according to the present exemplary embodiment of the present invention. However, the present invention may be implemented without being limited to use in a wireless sensor network. It may be considered to apply the present invention to, for example, a wide-area security system based on positional information. Further, it may also be considered to apply the present invention to, for example, an agricultural IT system freely controlling an environment (such as temperature, humidity, and an amount of sunlight) for agricultural products. The present invention may be applied to a general wireless communication system other than a wireless sensor network, such as an environment in which wireless LAN communication and wireless PAN communication coexist. Further, the present invention may be implemented by use of a band other than a 920 MHz band.

Further, it is assumed that the gateway 2 according to the present exemplary embodiment has a function of having control over both a WPAN standard and a WLAN standard. However, implementation of the present invention is not limited to the case described above. For example, the present invention may be implemented by including two nodes: one node having control over a WPAN standard and another node having control over a WLAN standard.

### Second Exemplary Embodiment

Next, a second exemplary embodiment of the present invention will be described with reference to the drawings. A case according to the second exemplary embodiment that a backhaul node serves as a WLAN access point (AP) and a gateway serves as a station (STA), will be described. A basic configuration is similar to the first exemplary embodiment. Therefore, parts characteristic of the present exemplary embodiment will be described below.

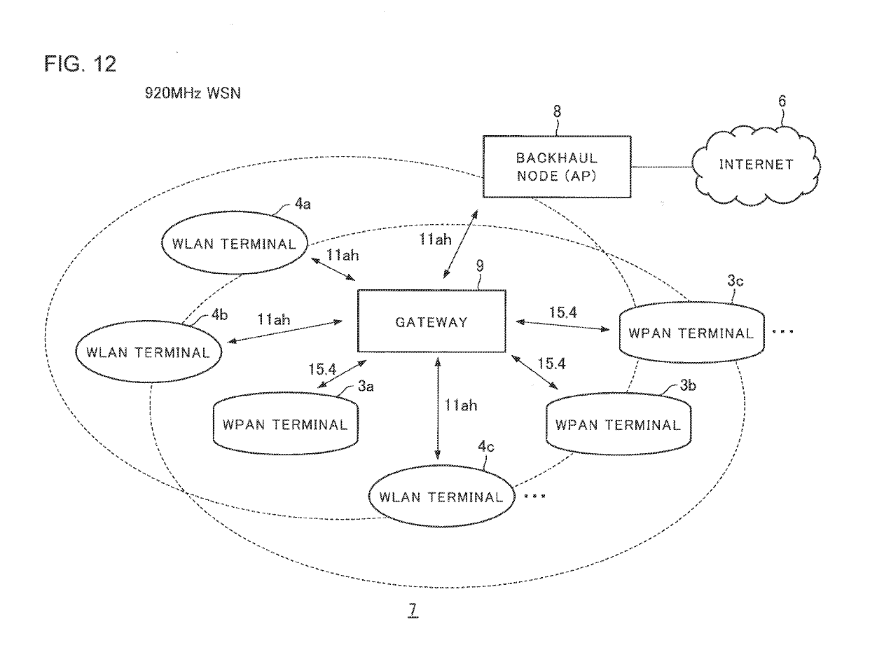

With reference to FIG. 12, a wireless sensor network 7 according to the present exemplary embodiment includes a gateway 9, WPAN terminals 3, WLAN terminals 4, and a backhaul node 8. A number of the gateway 9 included in the wireless sensor network 7 according to the present exemplary embodiment is not limited to one. The wireless sensor network 7 may include one gateway 9 or may include a large number of gateways 9. Further, in the present exemplary embodiment, a same reference sign is given to a same component described in the first exemplary embodiment. Parts characteristic of the present exemplary embodiment will be described below.

The backhaul node 8 according to the present exemplary embodiment is an access point in a WLAN standard. That is, the backhaul node 8 has a function of controlling wireless communication using a WLAN standard.

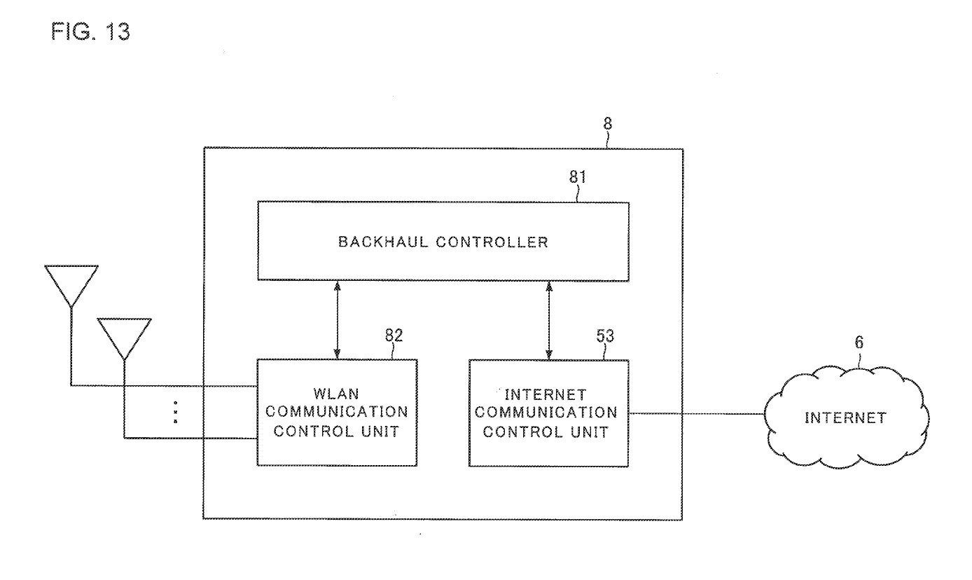

With reference to FIG. 13, the backhaul node 8 includes a backhaul controller 81, a WLAN communication control unit 82, and an Internet communication control unit 53. A configuration of the Internet communication control unit 53 is similar to that already described. Therefore, parts characteristic of the backhaul controller 81 and the WLAN communication control unit 82 will be described below.

The backhaul controller 81 according to the present exemplary embodiment has a function of timing synchronization between a harmonized controller 91, to be described later, in the gateway 9, and the backhaul controller 81, by communicating with the gateway 9. Further, the backhaul controller 81 has a function of determination and management of a superframe length SD, a beacon interval BI, and an NAV length DUR. Additionally, the backhaul controller 81 is configured to provide an instruction to the WLAN communication control unit 82 in the backhaul node 8 and a WPAN communication control unit 83 in the gateway 9 at a proper timing.

Roles of the backhaul controller 81 according to the present exemplary embodiment are listed, for example, as follows:
managing an SD and a BI in a WPAN and notifying the harmonized controller 91 of the SD and the BI,
synchronizing a beacon transmission timing in a WPAN and the harmonized controller 91 in the gateway 9,
managing a NAV length DUR in a WLAM,
issuing an instruction on a transmission timing of a CTS in a WLAN, and
managing a start of communication in a WLAN.

Thus, the backhaul controller 81 according to the present exemplary embodiment instructs the WLAN communication control unit 82 to transmit a CTS frame and to start WLAN communication. That is, the backhaul controller 81 is able to manage a WLAN standard. Management of a WPAN standard is performed through the gateway 9.

The WLAN communication control unit 82 has a function of performing WLAN-standard-based wireless communication with the WLAN terminal 4 and the gateway 9. As illustrated in FIG. 13, the WLAN communication control unit 82 includes an antenna unit and performs wireless communication with the WLAN terminal 4 and the gateway 9 through the antenna unit. Further, the WLAN communication control unit 82 according to the present exemplary embodiment performs wireless communication by use of a 920 MHz band. The WLAN communication control unit 82 transmits a CTS frame and starts WLAN-standard-based wireless communication, in accordance with an instruction from the backhaul controller 81.

The gateway 9 according to the present exemplary embodiment is a coordinator in a WPAN standard. Specifically, the gateway 9 has a function of controlling WPAN-standard-based wireless communication.

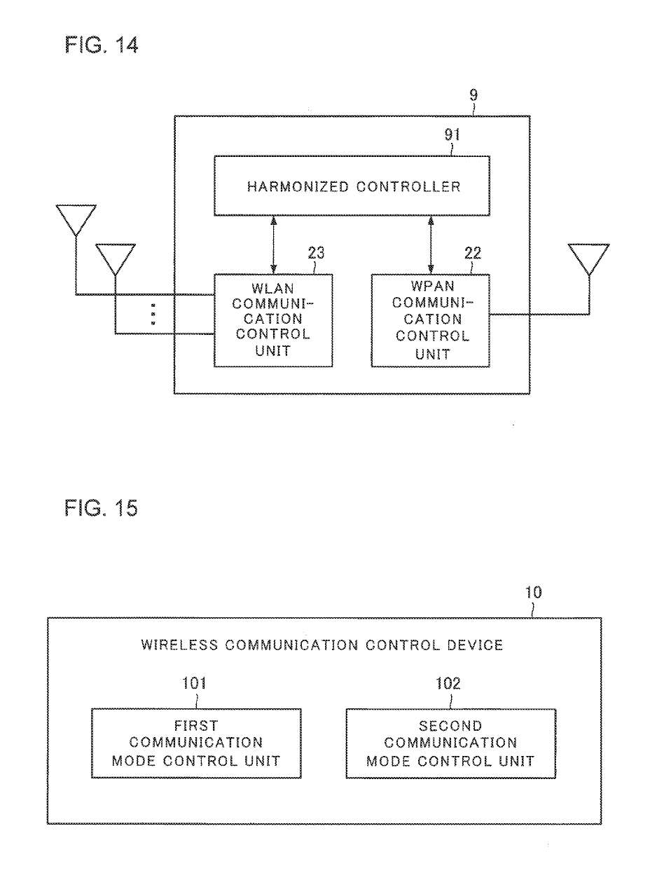

With reference to FIG. 14, the gateway 9 according to the present exemplary embodiment includes a harmonized controller 91, a WPAN communication control unit 22, and a WLAN communication control unit 23. Configurations of the WPAN communication control unit 22 and the WLAN communication control unit 23 are similar to those already described. Therefore, parts characteristic of the harmonized controller 91 will be described below.

The harmonized controller 91 according to the present exemplary embodiment has a function of controlling the WPAN communication control unit 22 in synchronization with a timing instruction from the backhaul node 8 (backhaul controller 81).

Roles of the harmonized controller 91 according to the present exemplary embodiment are listed, for example, as follows:
managing an SD and a BI in a WPAN,
issuing an instruction on a beacon transmission timing in a WPAN, and
transferring collected WPAN/WLAN communication data to the backhaul node 8.

Thus, the harmonized controller 91 according to the present exemplary embodiment instructs WPAN communication control unit 22 on a beacon transmission timing. Further, the harmonized controller 91 acquires and manages a superframe length SD and a beacon interval BI determined by the backhaul controller 81. That is, the harmonized controller 91 is able to manage a WPAN standard. As described above, management of a WLAN standard is performed through the backhaul node 8.

As described above, the wireless sensor network 7 according to the present exemplary embodiment includes the backhaul node 8 including the backhaul controller 81, and the gateway 9 including the harmonized controller 91. Further, the backhaul controller 81 is able to manage a WLAN standard. Further, the harmonized controller 91 is able to manage a WPAN standard.

With such a configuration, WLAN-standard-based wireless communication can be controlled not to be performed during a WPAN-standard-based wireless communication period, while the communication can be controlled to be performed outside a WPAN-standard-based wireless communication period.

Thus, interference between a WPAN-standard-based communication and WLAN-standard-based communication can be prevented. That is, when a plurality of wireless communication modes (a WPAN-standard-based wireless communication mode and a wireless-LAN-standard-based wireless communication mode) are simultaneously used, interference between the plurality of wireless communication modes can be effectively prevented.

Furthermore, the present exemplary embodiment is also able to provide management of a WPAN and a WLAN on separate nodes such as a gateway and a backhaul node, instead of on a same node.

### Third Exemplary Embodiment

Next a third exemplary embodiment of the present invention will be described with reference to the drawing.

With reference to FIG. 15, a wireless communication control device 10 according to the present exemplary embodiment includes a first communication mode control unit 101 and a second communication mode control unit 102.

The first communication mode control unit 101 is able to perform wireless communication by use of a first wireless communication mode.

The second communication mode control unit 102 is able to perform wireless communication by use of a second wireless communication mode. Further, the second communication mode control unit 102 has a function of detecting a start of wireless communication in the first wireless communication mode. When detecting a start of wireless communication in the first wireless communication mode (by the first communication mode control unit 101), the second communication mode control unit 102 operates not to perform wireless communication in the second wireless communication mode during a wireless communication period in the first wireless communication mode. Further, the second communication mode control unit 102 operates to perform wireless communication in the second wireless communication mode outside a wireless communication period in the first wireless communication mode.

With the aforementioned configuration, the wireless communication control device 10 is able to avoid performing wireless communication in the second wireless communication mode during a wireless communication period in the first wireless communication mode, while the device is able to perform wireless communication in the second wireless communication mode outside a wireless communication period in the first wireless communication mode.

Consequently, when a plurality of wireless communication modes (the first wireless communication mode and the second wireless communication mode) are simultaneously used, interference between the plurality of wireless communication modes can be effectively prevented.

Further, the aforementioned wireless communication control device 10 can be provided by incorporating a predetermined program into the wireless communication control device 10. Specifically, a program being another form of the present invention is a program providing a first communication mode control unit performing wireless communication in a first wireless communication mode, and a second communication mode control unit performing wireless communication in a second wireless communication mode, for a wireless communication control device, and causing the second communication mode control unit to operate to detect a start of wireless communication in the first wireless communication mode and not to perform wireless communication in the second wireless communication mode during a wireless communication period in the first wireless communication mode, and also to operate to perform wireless communication in the second wireless communication mode outside a wireless communication period in the first wireless communication mode.

Further, a wireless communication method practiced by operation of the aforementioned wireless communication control device 10 is a method detecting a start of wireless communication in a first wireless communication mode, controlling wireless communication in a second wireless communication mode not to be performed during a wireless communication period in the first wireless communication mode, and controlling wireless communication in the second wireless communication mode to be performed outside a wireless communication period in the first wireless communication mode.

Further, a case according to the present exemplary embodiment that one wireless communication control device includes the first communication mode control unit 101 and the second communication mode control unit 102 has been described. However, the present invention may be implemented without being limited to the case described above. The present invention may be, for example, a wireless communication control system including two nodes: a node having a function as the first communication mode control unit 101 and another node having a function as the second communication mode control unit 102. An invention of a program, a wireless communication method, or a wireless communication control system, having a configuration described above, provides a similar effect to the aforementioned wireless communication control device 10, and therefore is able to achieve the aforementioned object of the present invention.

Further, processing in the respective units may be performed by recording a program for providing the functions of the first to third exemplary embodiments described above, in whole or in part, on a computer-readable recording medium, and causing a computer system to read and execute the program recorded on the recording medium.

The “computer system” includes, for example, a central processing unit (CPU).

The “computer-readable recording medium” is, for example, a non-transitory storage device. The non-transitory storage device includes, for example, a portable medium such as a magneto-optical disk, a read only memory (ROM), a non-transitory semiconductor memory, and a hard disk incorporated into a computer system. Further, the “computer-readable recording medium” may be a transitory storage device. The transitory storage device includes, for example, a communication cable for transmitting a program through a network such as the Internet and a communication line such as a telephone line, and a volatile memory inside a computer system.

Further, the aforementioned program may provide part of the aforementioned functions, and may also provide the aforementioned functions in combination with a program already recorded in a computer system.

<Supplementary Notes>

The aforementioned exemplary embodiments may also be described in part or in whole as the following Supplementary Notes.

### (Supplementary Note 1)

A wireless communication control device including:

a first communication mode control unit performing wireless communication in a first wireless communication mode, and

a second communication mode control unit performing wireless communication in a second wireless communication mode, wherein

the second communication mode control unit detects a start of wireless communication in the first wireless communication mode, operates not to perform wireless communication in the second wireless communication mode during a wireless communication period in the first wireless communication mode, and operates to perform wireless communication in the second wireless communication mode outside a wireless communication period in the first wireless communication mode.

In this configuration, the wireless communication control device includes the first communication mode control unit and the second communication mode control unit. Further, the second communication mode control unit is configured to detect a start of wireless communication in the first wireless communication mode, and operate not to perform wireless communication in the second wireless communication mode during a wireless communication period in the first wireless communication mode. Additionally, the second communication mode control unit is configured to operate to perform wireless communication in the second wireless communication mode outside a wireless communication period in the first wireless communication mode. With such a configuration, the wireless communication control device is able to control communication in the first wireless mode and communication in the second wireless mode so that wireless communication in the second wireless communication mode is avoided during a first wireless communication period, while wireless communication in the second wireless communication mode is performed outside a wireless communication period in the first wireless communication mode. Consequently, interference between communication in the first wireless communication mode and communication in the second wireless communication mode can be prevented.

### (Supplementary Note 2)

The wireless communication control device according to Supplementary Note 1, wherein

the first communication mode control unit is set an active period being a period in which wireless communication is performed and an inactive period being a period in which wireless communication is not performed, and is configured to operate in accordance with the set periods, and

the second communication mode control unit detects a start of the active period of the first communication mode control unit, operates not to perform wireless communication in the second wireless communication mode during the active period, and operates to perform wireless communication in the second wireless communication mode during the inactive period.

### (Supplementary Note 3)

The wireless communication control device according to Supplementary Note 2, wherein

the second communication mode control unit detects a start and a length of the active period of the first communication mode control unit, and operates not to perform wireless communication in the second wireless communication mode during the active period corresponding to the detected length of the active period.

### (Supplementary Note 4)

The wireless communication control device according to Supplementary Note 3, further including

a control means for controlling operations of the first communication mode control unit and the second communication mode control unit, wherein

the control means instructs the second communication mode control unit to transmit a wireless communication signal including information indicating the active period, immediately before the first communication mode control unit transitions to the active period, and

the second communication mode control unit detects a start and a length of the active period by receiving the instruction, transmits outside a wireless communication signal including information indicating the active period, in accordance with the instruction, and subsequently operates not to perform wireless communication in the second wireless communication mode during the active period.

### (Supplementary Note 5)

The wireless communication control device according to Supplementary Note 4, wherein

the control means is configured to set the active period and the inactive period of the first communication mode control unit.

### (Supplementary Note 6)

The wireless communication control device according to Supplementary Note 5, wherein

the control means is configured to specify at least a beacon transmission period and a contention access period in which a wireless communication terminal performing wireless communication by use of the first wireless communication mode is not limited, as the active period.

### (Supplementary Note 7)

The wireless communication control device according to Supplementary Note 5 or 6, wherein

the first wireless communication mode is a Wireless Personal Area Network (WPAN) standard and the second wireless communication mode is a Wireless Local Area Network (WLAN) standard, and

the control means is configured to set the active period and the inactive period by setting a superframe length and a beacon interval to the first communication mode control unit.

### (Supplementary Note 8)

The wireless communication control device according to any one of Supplementary Notes 3 to 7, wherein

a wireless communication signal including information indicating an active period of the first communication mode control unit is a Clear To Send (CTS) signal.

### (Supplementary Note 9)

The wireless communication control device according to any one of Supplementary Notes 1 to 8, wherein the first wireless communication mode is a Wireless Personal Area Network (WPAN) standard, and the second wireless communication mode is a Wireless Local Area Network (WLAN) standard.

### (Supplementary Note 10)

A wireless communication control method of controlling wireless communication in a plurality of wireless communication modes, by use of a first communication mode control unit performing wireless communication in a first wireless communication mode, and a second communication mode control unit performing wireless communication in a second wireless communication mode, the method including, by the second communication mode control unit:

detecting a start of wireless communication in a first wireless communication mode, controlling wireless communication in a second wireless communication mode not to be performed during a wireless communication period in the first wireless communication mode, and controlling wireless communication in the second wireless communication mode to be performed outside a wireless communication period in the first wireless communication mode.

### (Supplementary Note 11)

The wireless communication control method according to Supplementary Note 10, wherein

the first communication mode control unit is set an active period being a period in which wireless communication is performed and an inactive period being a period in which wireless communication is not performed, and operates in accordance with the set periods, and

the second communication mode control unit detects a start of the active period of the first communication mode control unit, operates not to perform wireless communication in the second wireless communication mode during the active period, and operates to perform wireless communication in the second wireless communication mode during the inactive period.

### (Supplementary Note 12)

A storage medium storing a program for causing a computer in a wireless communication control device controlling wireless communication in a wireless communication mode, by use of a first communication mode control unit performing wireless communication in a first wireless communication mode, and a second communication mode control unit performing wireless communication in a second wireless communication mode, to perform,

processing of causing the second communication mode control unit to detect a start of wireless communication in the first wireless communication mode, operate not to perform wireless communication in the second wireless communication mode during a wireless communication period in the first wireless communication mode, and operate to perform wireless communication in the second wireless communication mode outside a wireless communication period in the first wireless communication mode.

### (Supplementary Note 13)

The storage medium according to Supplementary Note 12, wherein

the program includes processing of

causing the first communication mode control unit to set an active period being a period in which wireless communication is performed and an inactive period being a period in which wireless communication is not performed, and operate in accordance with the set periods, and

causing the second communication mode control unit to detect a start of the active period of the first communication mode control unit, operate not to perform wireless communication in the second wireless communication mode during the active period, and operate to perform wireless communication in the second wireless communication mode during the inactive period being outside the active period.

### (Supplementary Note 14)

A wireless communication control system including:

a first communication mode control device performing wireless communication in a first wireless communication mode, and

a second communication mode control device performing wireless communication in a second wireless communication mode, wherein

the second communication mode control device detects a start of wireless communication in the first wireless communication mode, operates not to perform wireless communication in the second wireless communication mode during a wireless communication period in the first wireless communication mode, and operates to perform wireless communication in the second wireless communication mode outside a wireless communication period in the first wireless communication mode.

### (Supplementary Note 15)

The wireless communication control system according to Supplementary Note 14, wherein

the first communication mode control unit is set an active period being a period in which wireless communication is performed and an inactive period being a period in which wireless communication is not performed, and is configured to operate in accordance with the set periods, and

the second communication mode control unit detects a start of the active period of the first communication mode control unit, operates not to perform wireless communication in the second wireless communication mode during the active period, and operates to perform wireless communication in the second wireless communication mode during the inactive period being outside the active period.

While the present invention has been described above with reference to the respective exemplary embodiments, the present invention is not limited to the aforementioned respective exemplary embodiments. Various changes and modifications that can be understood by a person skilled in the art may be made to the configurations and details of the present invention, within the scope of the present invention.

This application claims priority based on Japanese Patent Application No. 2014-038077 filed on Feb. 28, 2014, the disclosure of which is hereby incorporated by reference thereto in its entirety.

### REFERENCE SIGNS LIST

1, 7 Wireless sensor network
2, 9 Gateway
21, 91 Harmonized controller
22 WPAN communication control unit
23 WLAN communication control unit
3 WPAN terminal
31 Wireless communication unit
32 Control unit
33 Sensor
4 WLAN terminal
41 Wireless communication unit
42 Control unit
43 Sensor
5, 8 Backhaul node
51, 81 Backhaul controller
52, 82 WLAN communication control unit
53 Internet communication control unit
6 Internet
10 Wireless communication control device
101 First communication mode control unit
102 Second communication mode control unit

1. A wireless communication control device comprising:
a first communication mode control unit that performs wireless communication in a first wireless communication mode, and
a second communication mode control unit that performs wireless communication in a second wireless communication mode, wherein
the second communication mode control unit detects a start of wireless communication in the first wireless communication mode, operates not to perform wireless communication in the second wireless communication mode during a wireless communication period in the first wireless communication mode, and operates to perform wireless communication in the second wireless communication mode outside a wireless communication period in the first wireless communication mode.

2. The wireless communication control device according to claim 1, wherein
the first communication mode control unit is set an active period being a period in which wireless communication is performed and an inactive period being a period in which wireless communication is not performed, and is configured to operate in accordance with the set periods, and
the second communication mode control unit detects a start of the active period of the first communication mode control unit, operates not to perform wireless communication in the second wireless communication mode during the active period, and operates to perform wireless communication in the second wireless communication mode during the inactive period.

3. The wireless communication control device according to claim 2, wherein
the second communication mode control unit detects a start and a length of the active period of the first communication mode control unit, and operates not to perform wireless communication in the second wireless communication mode during the active period corresponding to the detected length of the active period.

4. The wireless communication control device according to claim 3, further comprising
a control unit that controls operations of the first communication mode control unit and the second communication mode control unit, wherein
the control unit instructs the second communication mode control unit to transmit a wireless communication signal including information indicating the active period, immediately before the first communication mode control unit transitions to the active period, and
the second communication mode control unit detects a start and a length of the active period by receiving the instruction, transmits outside, a wireless communication signal including information indicating the active period, in accordance with the instruction, and subsequently operates not to perform wireless communication in the second wireless communication mode during the active period.

5. The wireless communication control device according to claim 4, wherein
the control unit is configured to set the active period and the inactive period of the first communication mode control unit.

6. The wireless communication control device according to claim 5, wherein
the control unit is configured to specify at least a beacon transmission period and a contention access period in which a wireless communication terminal performing wireless communication by use of the first wireless communication mode is not limited, as the active period.

7. A wireless communication control method of controlling wireless communication in a plurality of wireless communication modes, by use of a first communication mode control unit performing wireless communication in a first wireless communication mode, and a second communication mode control unit performing wireless communication in a second wireless communication mode, the method comprising, by the second communication mode control unit:
detecting a start of wireless communication in a first wireless communication mode, controlling wireless communication in a second wireless communication mode not to be performed during a wireless communication period in the first wireless communication mode, and controlling wireless communication in the second wireless communication mode to be performed outside a wireless communication period in the first wireless communication mode.

8. The wireless communication control method according to claim 7, wherein
the first communication mode control unit is set an active period being a period in which wireless communication is performed and an inactive period being a period in which wireless communication is not performed, and operates in accordance with the set periods, and
the second communication mode control unit detects a start of the active period of the first communication mode control unit, operates not to perform wireless communication in the second wireless communication mode during the active period, and operates to perform wireless communication in the second wireless communication mode during the inactive period.

9. (canceled)

10. A wireless communication control system comprising:
a first communication mode control device performing wireless communication in a first wireless communication mode, and
a second communication mode control device performing wireless communication in a second wireless communication mode, wherein
the second communication mode control device detects a start of wireless communication in the first wireless communication mode, operates not to perform wireless communication in the second wireless communication mode during a wireless communication period in the first wireless communication mode, and operates to perform wireless communication in the second wireless communication mode outside a wireless communication period in the first wireless communication mode.

11. The wireless communication control device according to claim 5, wherein
the first wireless communication mode is a Wireless Personal Area Network (WPAN) standard and the second wireless communication mode is a Wireless Local Area Network (WLAN) standard, and
the control unit is configured to set the active period and the inactive period by setting a superframe length and a beacon interval to the first communication mode control unit.

12. The wireless communication control device according to claim 6, wherein
the first wireless communication mode is a Wireless Personal Area Network (WPAN) standard and the second wireless communication mode is a Wireless Local Area Network (WLAN) standard, and
the control unit is configured to set the active period and the inactive period by setting a superframe length and a beacon interval to the first communication mode control unit.

13. The wireless communication control device according to claim 3, wherein
a wireless communication signal including information indicating an active period of the first communication mode control unit is a Clear To Send (CTS) signal.

14. The wireless communication control device according to claim 4, wherein
a wireless communication signal including information indicating an active period of the first communication mode control unit is a Clear To Send (CTS) signal.

15. The wireless communication control device according to claim 5, wherein
a wireless communication signal including information indicating an active period of the first communication mode control unit is a Clear To Send (CTS) signal.

16. The wireless communication control device according to claim 6, wherein
a wireless communication signal including information indicating an active period of the first communication mode control unit is a Clear To Send (CTS) signal.

17. The wireless communication control device according to claim 1, wherein
the first wireless communication mode is a Wireless Personal Area Network (WPAN) standard, and the second wireless communication mode is a Wireless Local Area Network (WLAN) standard.

18. The wireless communication control device according to claim 2, wherein
the first wireless communication mode is a Wireless Personal Area Network (WPAN) standard, and the second wireless communication mode is a Wireless Local Area Network (WLAN) standard.

19. The wireless communication control device according to claim 3, wherein
the first wireless communication mode is a Wireless Personal Area Network (WPAN) standard, and the second wireless communication mode is a Wireless Local Area Network (WLAN) standard.

20. The wireless communication control device according to claim 4, wherein
the first wireless communication mode is a Wireless Personal Area Network (WPAN) standard, and the second wireless communication mode is a Wireless Local Area Network (WLAN) standard.

21. The wireless communication control device according to claim 5, wherein
the first wireless communication mode is a Wireless Personal Area Network (WPAN) standard, and the second wireless communication mode is a Wireless Local Area Network (WLAN) standard.
